(19) United States
(12) Patent Application Publication
(10) Pub. No.: US 2021/0295182 A1
(43) Pub. Date: Sep. 23, 2021

(54) MACHINE LEARNING SYSTEM AND MACHINE LEARNING METHOD

(71) Applicant: HITACHI, LTD., Tokyo (JP)

(72) Inventors: Naoyuki TERASHITA, Tokyo (JP); Kenta TAKANOHASHI, Tokyo (JP); Yuuichi NONAKA, Tokyo (JP)

(73) Assignee: HITACHI, LTD., Tokyo (JP)

(21) Appl. No.: 17/017,928

(22) Filed: Sep. 11, 2020

(30) Foreign Application Priority Data
Mar. 23, 2020 (JP) 2020-051527

(51) Int. Cl. G06N 5/04; G06N 20/00

(52) U.S. Cl. CPC G06N 5/04; G06N 20/00

(57) ABSTRACT

A machine learning system determines whether an influence which exclusion and addition of evaluation target data from and to learning data has on the performance of a machine learning model includes: an acquisition unit that acquires an initial data group used to learn a learning model, evaluation target data added to, or excluded from, the initial data group, and a verification data group including at least one element which is not included in the evaluation target data; and a contribution degree calculation unit that calculates a contribution degree for evaluating an influence which the evaluation target data has on performance of the learning model, on the basis of an output value by the learning model for which the verification data group is input, and an output value by a relearning model which is learned by adding or excluding the evaluation target data to or from the initial data group.

### TECHNICAL FIELD

The present invention relates to a machine learning system and a machine learning method.

### BACKGROUND ART

There is a technique described in NPL 1 to correct learning data used for machine learning. NPL 1: describes that “[w]e show that influence functions can help human experts prioritize their attention, allowing them to inspect only the examples that actually matter”; and also describes that “we measure the influence of zi with loss (zi, zi), which approximates the error incurred on zi if we remove zi from the training set.”

### CITATION LIST

### Non Patent Literature

NPL 1: Pang Wei Koh, Percy Liang, “Understanding Black-box Predictions via Influence Functions,” Jul. 10, 2017, [online], [searched on Feb. 28, 2020], the Internet <URL: https://arxiv.org/pdf/1703.04730.pdf>

### SUMMARY OF THE INVENTION

### Problems to be Solved by the Invention

The technique described in NPL 1 evaluates evaluation target data by using the difference between a loss value of the evaluation target data of a machine learning model, which has been learned by using an initial data group including the evaluation target data, and a loss value of the evaluation target data of a machine learning model obtained by excluding the evaluation target data from the initial data group. When this is performed, the loss value difference has the same sign of the evaluation target data; and, therefore, you cannot tell whether the influence which the exclusion of the evaluation target data has on the machine learning model is good or bad.

The present invention was devised in consideration of the above-described circumstances and it is an object of the invention to make it possible to find out whether the influence which the exclusion and addition of the evaluation target data from and to the learning data has on the performance of the machine learning model is good or bad, on the basis of any change in an output value to a verification data group to judge the performance of the machine learning model.

### Means to Solve the Problems

In order to solve the above-described problem, provided according to an aspect of the present invention is a machine learning system including: an acquisition unit that acquires an initial data group used to learn a learning model, evaluation target data added to, or excluded from, the initial data group, and a verification data group including at least one element which is not included in the evaluation target data; and a contribution degree calculation unit that calculates a contribution degree for evaluating an influence which the evaluation target data has on performance of the learning model, on the basis of an output value by the learning model for which the verification data group is input, and an output value by a relearning model which is learned by adding or excluding the evaluation target data to or from the initial data group.

### Advantageous Effects of the Invention

According to the present invention, whether the influence which the exclusion and addition of the evaluation target data from and to the learning data has on the performance of the machine learning model is good or bad can be found out on the basis of any change in the output value with respect to the verification data group.

### BRIEF DESCRIPTION OF DRAWINGS

FIG. 1 is a block diagram illustrating a configuration example of a machine learning system according to Embodiment 1;

FIG. 2 is a flowchart illustrating a processing sequence for the machine learning system according to Embodiment 1;

FIG. 3 is a flowchart illustrating a processing sequence for the machine learning system according to Embodiment 3;

FIG. 4 is a block diagram illustrating a configuration example of a machine learning system according to Embodiment 4;

FIG. 5 is a diagram illustrating a display example of an evaluation target data correction form according to Embodiment 4;

FIG. 6 is a block diagram illustrating a configuration example of a machine learning system according to Embodiment 5;

FIG. 7 is a diagram illustrating a display example of a verification data group correction form according to Embodiment 5;

FIG. 8 is a block diagram illustrating a configuration example of a machine learning system according to Embodiment 6; and

FIG. 9 is a hardware diagram of a computer for implementing the machine learning system.

### DESCRIPTION OF EMBODIMENTS

Embodiments of a machine learning system and a machine learning method according to the present invention will be explained below with reference to the drawings. Incidentally, in the following explanation, the same reference numeral will be assigned, as a general rule, to the same or similar elements and processing. Moreover, any redundant explanations will be omitted about the same function and processing. Furthermore, in the explanation of the embodiments, an explanation about any duplicate part of an embodiment(s) which has already been explained will be omitted.

The configurations and processing explained below are merely examples and it is not intended to limit such embodiments according to the present invention to specific aspects described below. Furthermore, any parts or whole of the respective embodiments and variations can be combined unless any contradiction occurs.

### Embodiment 1

<<Outline of Embodiment 1>>

In this embodiment, when verification data which does not include any part identical to evaluation target data is used and evaluation data is added to, or excluded from, a learning data group, the evaluation target data whose contribution degree described later is positive is judged that it requires to be corrected; and the evaluation target data whose contribution degree is negative is judged that it requires no correction; and the evaluation target data is automatically corrected on the basis of the judgment result.

In this embodiment, a machine learning model is used for a facility appearance inspection. Facilities are, for example, buildings, bridges, and infrastructures. Learning data is configured by including facility appearance images acquired by using an image capturing apparatus (which is not illustrated in the drawings), and label information indicating whether a facility appearance image given by a user includes any defect or not. The defect is, for example, rust, deformations, and cracks found in the facility appearance. Furthermore, a learning data group includes learning data of a non-defective facility appearance image to which defective and incorrect label information is assigned.

In this embodiment, the “correction” and “automatic correction” mean to: store only the evaluation target data whose contribution degree is negative and which is judged that it requires no correction, in a corrected data storage unit 103 described later; and recognize the evaluation target data whose contribution degree is positive and which is judged that it requires to be corrected, as a non-target which should not be stored in the corrected data storage unit 103.

In this embodiment, an “XXX data group” is one or more pieces of XXX data.

The machine learning model in this embodiment is a function that is learned, by inputting one or more facility appearance images, to: output “True” if the facility image(s) includes any defect; and output “False” if the facility image(s) includes no defect.

<<Configuration of Machine Learning System 100 According to Embodiment 1>>

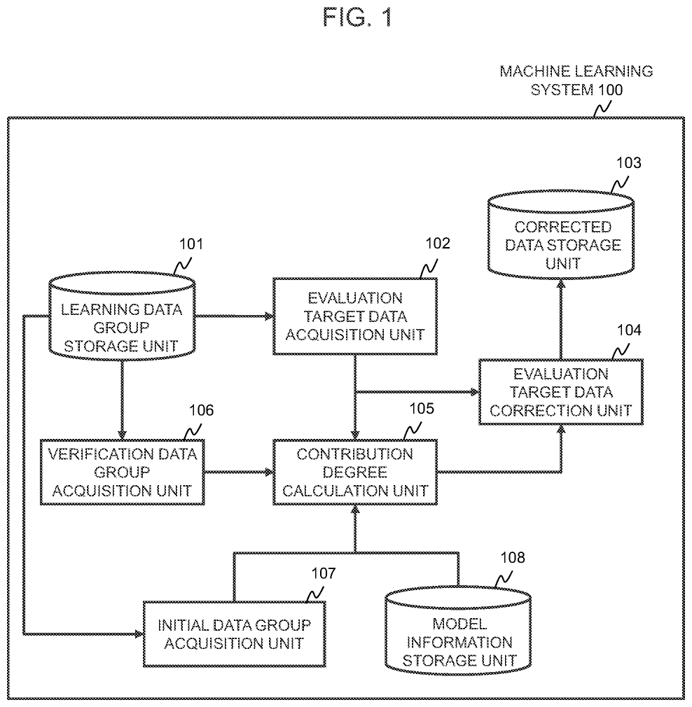

FIG. 1 is a block diagram illustrating a configuration example of a machine learning system 100 according to Embodiment 1. Referring to FIG. 1, the machine learning system 100 includes a learning data group storage unit 101, an evaluation target data acquisition unit 102, a corrected data storage unit 103, an evaluation target data correction unit 104, a contribution degree calculation unit 105, a verification data group acquisition unit 106, an initial data group acquisition unit 107, and a model information storage unit 108.

The initial data group acquisition unit 107 acquires an initial data group Z_{train,k} (k=1, 2, . . . , n [n hereinafter represents an initial learning data quantity]), which is a learning data group used by a learning unit (which is not illustrated in the drawing), from the learning data group storage unit 101. However, this learning unit performs optimization as indicated in Mathematical Expression 1 by using the initial data group Z_{train,k} (k=1, 2, . . . , n) and stores an initial model parameter θᵢₙᵢₜ, which is a solution of the optimization, in the model information storage unit 108.

$${θ}_{init} := {argmin}_{θ} \frac{1}{n} {\sum }_{k = 1}^{n} L ( {z}_{train , k} , θ ) \qquad [ Math . 1 ]$$

It should be noted, however, that θ is a model parameter of a machine learning model and L is a loss function of the machine learning model. Incidentally, learning data which constitute the initial data group Z_{train,k} (k=1, 2, . . . , n) is called initial data Z_{train,k}.

The model information storage unit 108 stores machine learning model structure information and the initial model parameter θᵢₙᵢₜ. The machine learning model structure information is necessary information to construct calculation graphs of the machine learning model.

The evaluation target data acquisition unit 102 acquires evaluation target data Zₑᵥₐₗ, which is target learning data to judge whether it is a correction target or not, from the learning data group storage unit 101. Incidentally, the evaluation target data Zₑᵥₐₗ may be included in the initial data group Z_{train,k} (k=1, 2, . . . , n).

The verification data group acquisition unit 106 acquires a verification data group Z_{vaid,j} (j=1, 2, . . . , m [m hereinafter represents a verification data quantity]) from the learning data group storage unit 101. The verification data group Z_{vaid,j} (j=1, 2, . . . , m) includes at least one element (learning data) which is not included in the evaluation target data Zₑᵥₐₗ.

Consequently, the learning data group storage unit 101 stores all pieces of learning data included in the initial data group Z_{train,k} (k=1, 2, . . . , n), the evaluation target data Zₑᵥₐₗ, and the verification data group Z_{vaid,j} (j=1, 2, . . . , m).

The contribution degree calculation unit 105 inputs the machine learning model structure information and the initial model parameter Bina from the model information storage unit 108, the initial data group Z_{train,k} (k=1, 2, . . . , n) from the initial data group acquisition unit 107, the evaluation target data Zₑᵥₐₗ from the evaluation target data acquisition unit 102, and the verification data group Z_{vaid,j} (j=1, 2, . . . , m) from the verification data group acquisition unit 106 and outputs the contribution degree(s) described below.

An explanation will be provided below about two types of the contribution degree as the contribution degree calculated in Embodiment 1, that is, a “contribution degree for evaluating any change of performance of the machine learning model by addition of the evaluation target data” and a “contribution degree for evaluating any change of performance of the machine learning model by exclusion of the evaluation target data.” Moreover, an explanation will be also provided about a “self-contribution degree for evaluating any change of performance of the machine learning model according to a conventional technology” as comparison with the above-mentioned contribution degrees.

(1. Contribution Degree for Evaluating Change of Performance of Machine Learning Model by Addition of Evaluation Target Data) Firstly, an explanation will be provided about the case where any change of performance of the machine learning model by additional relearning of the evaluation target data is evaluated. A contribution degree f indicating the change of performance of the machine learning model in the case of additional relearning is given by Mathematical Expression 2 by using the evaluation target data Zₑᵥₐₗ and the verification data group Z_{vaid,j} (j=1, 2, . . . , m).

$$\begin{matrix}f ( {z}_{eval} ) := \frac{1}{m} {\sum }_{j = 1}^{m} L ( {z}_{valid , j} , {θ}_{add} ( {z}_{eval} ) ) - \frac{1}{m} {\sum }_{j = 1}^{m} L ( {z}_{valid , j} , {θ}_{init} ) \\ where & [ Math . 2 ] \\ {θ}_{add} ( {z}_{eval} ) = {argmin}_{θ} \frac{1}{n} ( {\sum }_{k = 1}^{n} L ( {z}_{train , k} , θ ) + L ( {z}_{eval} , θ ) ) & [ Math . 3 ]\end{matrix}$$

The first term on the right side of Mathematical Expression 2 is an average value of a loss value L obtained by inputting the verification data group Z_{vaid,j} (j=1, 2, . . . , m) to an evaluation machine learning model obtained by the additional relearning to learn the machine learning model by using the learning data group obtained by adding the evaluation target data Zₑᵥₐₗ to the initial data group Z_{train,k} (k=1, 2, . . . , n). Moreover, the second term on the right side of Mathematical Expression 2 is an average of the loss value L obtained by inputting the verification data group Z_{vaid,j} (j=1, 2, . . . , m) to the machine learning model which has the initial model parameter θᵢₙᵢₜ.

Therefore, if the contribution degree f is positive, it is expected to increase the loss of the verification data group Z_{vaid,j} (j=1, 2, . . . , m) by adding the evaluation target data Zₑᵥₐₗ to the initial data group Z_{train,k} (k=1, 2, . . . , n), that is, to deteriorate the performance of the machine learning model with respect to the verification data group; and if the contribution degree f is negative, it is expected to enhance the performance of the machine learning model.

As a result, it is possible to find out, by using the contribution degree f, whether the influence which the addition of the evaluation target data Zₑᵥₐₗ has on the performance of the machine learning model with respect to the verification data group which is not used for learning is good or bad.

(2. Contribution Degree for Evaluating Change of Performance of Machine Learning Model by Exclusion of Evaluation Target Data) Next, an explanation will be provided about the case where any change of performance of the machine learning model by learning with exclusion of the evaluation target data is evaluated. A contribution degree fᵣₑₘₒᵥₑ indicating a change of the performance of the machine learning model when the evaluation target data Zₑᵥₐₗ is included in the initial data group Z_{train,k} (k=1, 2, . . . , n) and the evaluation target data Zₑᵥₐₗ is excluded from learning is given by Mathematical Expression 4 by using the evaluation target data Zₑᵥₐₗ and the verification data group Z_{vaid,j} (j=1, 2, . . . , m).

$$\begin{matrix}{f}_{remove} ( {z}_{eval} ) := - \frac{1}{m} {\sum }_{j = 1}^{m} L ( {z}_{valid , j} , {θ}_{remove} ( {z}_{eval} ) ) + \frac{1}{m} {\sum }_{j = 1}^{m} L ( {z}_{valid , j} , {θ}_{init} ) \\ where & [ Math . 4 ] \\ {θ}_{remove} ( {z}_{eval} ) = {argmin}_{θ} \frac{1}{n} ( {\sum }_{k = 1}^{n} L ( {z}_{train , k} , θ ) + L ( {z}_{eval} , θ ) ) & [ Math . 5 ]\end{matrix}$$

The first term on the right side of Mathematical Expression 4 is an average value of the loss value L obtained by inputting the verification data group Z_{vaid,j} (j=1, 2, . . . , m) to the evaluation machine learning model obtained by relearning of the machine learning model by using the learning data group obtained by excluding the evaluation target data Zₑᵥₐₗ from the initial data group Z_{train,k} (k=1, 2, . . . , n). Moreover, the second term on the right side of Mathematical Expression 4 is an average of the loss value L obtained by inputting the verification data group Z_{vaid,j} (j=1, 2, . . . , m) to the machine learning model which has the initial model parameter θᵢₙᵢₜ.

(3. Self-Contribution Degree for Evaluating Change of Performance of Machine Learning Model According to Conventional Technology)

Now, the contribution degree for evaluating any change of the performance of the machine learning model on the basis of the self-contribution degree according to the conventional technology will be explained. Characteristics regarding which whether the influence on the performance is good or bad can be found on the basis of simple criteria like whether positive or negative are implemented by the feature that the verification data group Z_{vaid,j} (j=1, 2, . . . , m) includes at least one piece of learning data which is not included in the initial data group Z_{train,k} (k=1, 2, . . . , n) or the evaluation target data Zₑᵥₐₗ. An explanation will be provided about the case, like the conventional technology, where the feature of the verification data group Z_{vaid,j} (j=1, 2, . . . , m) is not satisfied, that is, where the verification data group Z_{vaid,j} (j=1, 2, . . . , m) is one piece of learning data identical to the evaluation target data Zₑᵥₐₗ. In this case, the contribution degree f_{self} (self-contribution degree) is given by Mathematical Expression 6.

[Math. 6]

f_{self}(Zₑᵥₐₗ):=Zₑᵥₐₗ,θ_{add}(Zₑᵥₐₗ))−L(zₑᵥₐₗ,θᵢₙᵢₜ)

The first term on the right side of Mathematical Expression 6 is the loss value L obtained by performing additional relearning to learn the machine learning model by using the learning data group obtained by adding the evaluation target data Zₑᵥₐₗ to the initial data group Z_{train,k} (k=1, 2, . . . , n) and inputting the evaluation target data Zₑᵥₐₗ to the evaluation machine learning model obtained by the additional relearning. The second term on the right side is the loss value L obtained by inputting the evaluation target data Zₑᵥₐₗ to the machine learning model which has the initial model parameter θᵢₙᵢₜ.

In this case, the loss value L of the evaluation target data Zₑᵥₐₗ decreases as a result of the additional relearning as compared to the case of the initial model parameter θᵢₙᵢₜ, the contribution degree self is f always negative. Accordingly, if the feature of the verification data group Z_{vaid,j} (j=1, 2, . . . , m) is not satisfied as described above, it is difficult to find out whether the change of the performance is good or bad, on the basis of the simple criteria such as whether the contribution degree f_{self} is positive or negative.

Furthermore, “the error incurred on zi if we remove zi from the training set” as described in “5.4. Fixing mislabeled examples” of NPL 1 is the special case where Mathematical Expression 6 satisfies Mathematical Expression 7; and similarly, it is difficult to find out whether the change of the performance is good or bad, on the basis of the simple criteria such as positive or negative.

[Math. 7]

Zₑᵥₐₗ∈{Z_{train,0} . . . Z_{train,n}}

Furthermore, in this embodiment, the verification data group Z_{vaid,j} (j=1, 2, . . . , m) has such a feature that it has a sufficient data quantity to represent a population of the learning data. This feature makes it possible to estimate the change which the exclusion and addition of the evaluation target data Zₑᵥₐₗ will cause to the performance relative to the population of the learning data.

The evaluation target data correction unit 104 inputs the contribution degree (f or fᵣₑₘₒᵥₑ) from the contribution degree calculation unit 105 and inputs the evaluation target data Zₑᵥₐₗ from the evaluation target data acquisition unit 102; and if the contribution degree is negative, the evaluation target data correction unit 104 determines that the evaluation target data Zₑᵥₐₗ requires no correction, and stores the evaluation target data Zₑᵥₐₗ in the corrected data storage unit 103. Also, if the contribution degree is positive, the evaluation target data correction unit 104 does not store the evaluation target data Zₑᵥₐₗ in the corrected data storage unit 103. Incorrect learning data results in the positive contribution degree. Therefore, any incorrect learning data will not be stored in the corrected data storage unit 103, but learning data which is not incorrect will be stored in the corrected data storage unit 103.

<<Processing of Machine Learning System 100 According to Embodiment 1>>

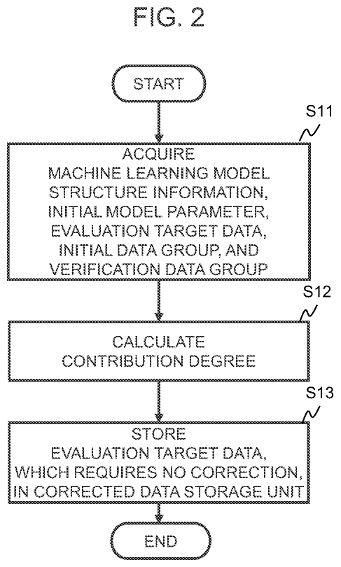

FIG. 2 is a flowchart illustrating a processing sequence of the machine learning system 100 according to Embodiment 1. Firstly in step S11, the contribution degree calculation unit 105 acquires the machine learning model structure information, the initial model parameter θᵢₙᵢₜ, the initial data group Z_{train,k} (k=1, 2, . . . , n), the evaluation target data Zₑᵥₐₗ, and the verification data group Z_{vaid,j} (j=1, 2, . . . , m).

Next in step S12, the contribution degree calculation unit 105 calculates the contribution degree on the basis of the data acquired in step S11 by using Mathematical Expression 2 or Mathematical Expression 3. Then in step S13, the evaluation target data correction unit 104 stores the evaluation target data, whose contribution degree is negative, that is, which requires no correction, in the corrected data storage unit 103.

<<Advantageous Effect of Embodiment 1>>

According to this embodiment, the machine learning system 100 can judge whether the influence which the evaluation target data has on the performance of the machine learning model is good or bad, on the basis of whether the contribution degree is positive or negative, so that it is possible to easily make the correction necessity judgment which is necessary for automatic correction of the evaluation target data.

<<Variations of Embodiment 1>>

The evaluation target data correction unit 104 may decide whether the correction is required or not as follows: if the contribution degree is equal to or larger than a judgment reference value which is decided by a user in advance, the evaluation target data correction unit 104 may decide that the evaluation target data requires to be corrected; and if the contribution degree is smaller than the above-described judgment reference value, the evaluation target data correction unit 104 may decide that the evaluation target data requires no correction. Under this circumstance, it is assumed that the judgment reference value is a value sufficiently close to 0 as compared to the average value of the loss of the verification data group. Accordingly, only the evaluation target data which may have a certain level of adverse influence or more adverse influence can be determined that it requires to be corrected. Moreover, if a sample quantity of the verification data group is small and there is an error in the estimation of the change of the performance of the population which will be caused by the evaluation target data, whether the evaluation target data requires to be corrected or not can be judged with good accuracy.

Furthermore, this embodiment has described the case, as an example, where there is one piece of evaluation target data; however, an evaluation target data group composed of a plurality of pieces of evaluation target data may be used instead of the evaluation target data. In this case, the evaluation target data acquisition unit 102 acquires the evaluation target data group that is a learning data group which is set as a correction target by the user in advance. Also, the contribution degree calculation unit 105 outputs a contribution degree vector which has the same quantity of elements of the learning data quantity of the evaluation target data group and regarding which each element is a contribution degree for each piece of the evaluation target data. Moreover, the evaluation target data correction unit 104 stores the evaluation target data whose contribution degree is negative, among the evaluation target data group, in the corrected data storage unit 103 on the basis of the contribution degree vector.

Furthermore, this embodiment is designed so that if the correction necessity information indicates that the relevant data requires no correction, the evaluation target data correction unit 104 stores the evaluation target data in the corrected data storage unit 103; however, this embodiment is not limited to this example. Specifically speaking, in the case of the additional relearning of the evaluation data, if the correction necessity information indicates that the relevant data requires no correction, the evaluation target data correction unit 104 may output the evaluation target data to the learning unit (which is not illustrated in the drawing). In this case, the learning unit performs additional relearning of the machine learning model by using the learning data group including the evaluation target data, which has been output and requires no correction, and the initial learning data group. Alternatively, in the case of relearning after exclusion of the evaluation data, if the correction necessity information indicates that the relevant data requires no correction, the evaluation target data correction unit 104 may output the evaluation target data to the learning unit (which is not illustrated in the drawing). In this case, the learning unit performs relearning of the machine learning model by using the learning data group obtained by excluding the evaluation target data, which requires to be corrected, from the initial learning data group.

Furthermore, images which are input to the machine learning model are not limited to facility appearance images, but may be industrial product appearance images and images which have captured documents. Furthermore, the machine learning model may not be learned to output whether the facility appearance image is defective or not, but may be learned to classify images, which are input, into three classes or more, or may be learned to output positional information of objects in the relevant image and a class number. Moreover, in this embodiment, the learning and evaluation target data are images; however, the learning and evaluation target data are not limited to the image data.

Furthermore, the learning data group may be composed of only the learning data in which the facility appearance image does not include any defect; and in this case, the machine learning model may be learned to generate a facility appearance image which does not include any defect and the generated facility appearance image is used to judge whether or not any defect exists in the input image.

Furthermore, the incorrect learning data is not limited to the learning data in which the label information which is defective accompanies the facility appearance image which is non-defective. The criteria to recognize the relevant data as the incorrect learning data are that the relevant learning data is inappropriate for learning of the machine learning model, for example, the facility appearance is not included in the image, the facility appearance is not properly captured due to causes such as improper focus or blurring, or the facility appearance image is one frame in a video and the frame contains compressed noise of the video. Incidentally, the criteria to recognize the relevant data as the incorrect evaluation target data and the incorrect verification data are also the same as those for the incorrect learning data.

### Embodiment 2

<<Outline of Embodiment 2>>

As compared to Embodiment 1, this embodiment is different in that the contribution degree calculation unit 105 reduces calculation time by calculating an approximate value of the contribution degree.

<<Approximate Contribution Degree Calculation Processing According to Embodiment 2>>

Regarding the calculation of the contribution degree, a large calculation cost is required for the additional relearning. So, the contribution degree calculation unit 105 gives the contribution degree as an approximate contribution degree which can be calculated with a relatively small cost. Specifically speaking, the contribution degree calculation unit 105 uses the approximate contribution degree which is derived as follows. Firstly, the right side of Mathematical Expression 2 is transformed as in Mathematical Expression 8.

$$- \{ \frac{1}{m} {\sum }_{j = 1}^{m} L ( {z}_{valid , j} , {θ}_{init} ) - \frac{1}{m} {\sum }_{j = 1}^{m} L ( {z}_{valid , j} , {θ}_{add} ( {z}_{eval} ) ) \} = - \frac{1}{m} {\sum }_{j = 1}^{m} \{ L ( {z}_{valid , j} , {θ}_{init} ) - ( {z}_{valid , j} , {θ}_{add} ( {z}_{eval} ) ) \} \qquad [ Math . 8 ]$$

By using the approximation technique described in “2.1. Upweighting a training point” of NPL 1, the part in curly braces on the right side of Mathematical Expression 8 can be approximated as in Mathematical Expression 9.

[Math. 9]

L(Z_{valid,j},θ_{add}(Zₑᵥₐₗ))−L(Z_{valid,j},θᵢₙᵢₜ)≈1/n∇_{θ}L(Zₑᵥₐₗ,θᵢₙᵢₜ)^{T}H⁻¹∇_{θ}L(Z_{valid,j},θᵢₙᵢₜ)

However, a Hessian matrix H of Mathematical Expression 9 is given on the basis of the initial data group Z_{train,k} (k=1, 2, . . . , n)) and the initial model parameter Bina as in Mathematical Expression 10.

$$H = \frac{1}{n} {\sum }_{k = 1}^{n} {∇}_{θ}^{2} L ( {z}_{train , k} , {θ}_{init} ) \qquad [ Math . 10 ]$$

Now, a calculation method of an inverse HVP (Hessian Vector Product)(=A) in Mathematical Expression 9 as indicated in Mathematical Expression 11 will be explained.

[Math. 11]

A=H⁻¹∇_{θ}L(Z_{valid,j},θᵢₙᵢₜ)

Regarding the calculation of the inverse matrix of the Hessian matrix H, the calculation cost is extremely high if the model parameter quantity is large. So, an exact value calculation method described in Chapter 3 “Conjugate gradients (CG)” of NPL 1 or an approximation calculation method described in Chapter 3 “Stochastic estimation” of NPL 1 is used for the calculation of the inverse HVP.

Both the exact value calculation method and the approximation calculation method obtain the product of the inverse matrix of the Hessian matrix H and an arbitrary vector without calculating the inverse matrix of the Hessian matrix. So, the computational complexity is relatively small. In this embodiment, the inverse HVP is obtained by calculating the product of the inverse matrix of the Hessian matrix H and a model parameter gradient vector in the vicinity of the verification data by using the exact value calculation method or the approximation calculation method.

An approximate contribution degree f(Zₑᵥₐₗ) is obtained as indicated in Mathematical Expression 12 according to Mathematical Expression 8 and Mathematical Expression 9.

$$f ( {z}_{e v a l} ) ≅ \frac{1}{m n} {\sum }_{j = 1}^{m} {∇}_{θ} {L ( {z}_{e v a l} , {θ}_{init} )}^{T} {H}^{- 1} {∇}_{θ} L ( {z}_{valid , j} , {θ}_{init} ) \qquad [ Math . 12 ]$$

<<Advantageous Effect of Embodiment 2>>

Since the additional relearning is unnecessary according to this embodiment, the calculation time of the contribution degree can be shortened.

### Embodiment 3

<<Approximate Contribution Degree Calculation Processing According to Embodiment 3>>

This embodiment is the case where the contribution degree calculation unit 105 further reduces the calculation time by using the sum of model parameter gradient vectors in the vicinity of the verification data group in Embodiment 2. In Mathematical Expression 12 of Embodiment 2, it is necessary to execute the calculation of the inverse HVP m times to calculate the approximate contribution degree. The problem of this embodiment is that the m times of calculation of the inverse HVP will lead to an increase of the calculation time.

This embodiment is the case where the approximate contribution degree equivalent to that of Embodiment 2 is calculated by one-time calculation of the inverse HVP by a method described below. According to the matrix distributive law, Mathematical Expression 12 can be changed to Mathematical Expression 13.

$$f ( {z}_{e v a l} ) ≅ \frac{1}{m n} {∇}_{θ} {L ( {z}_{e v a l} , {θ}_{i n i t} )}^{T} {H}^{- 1} {\sum }_{j = 1}^{m} {∇}_{θ} L ( {z}_{valid , j} , {θ}_{init} ) \qquad [ Math . 13 ]$$

According to Mathematical Expression 13, you can see that the product of the inverse matrix of the Hessian matrix H and the sum of the model parameter gradient vectors of the verification data group Z_{vaid,j} (j=1, 2, . . . , m) can give the approximate contribution degree equivalent to that of Mathematical Expression 12.

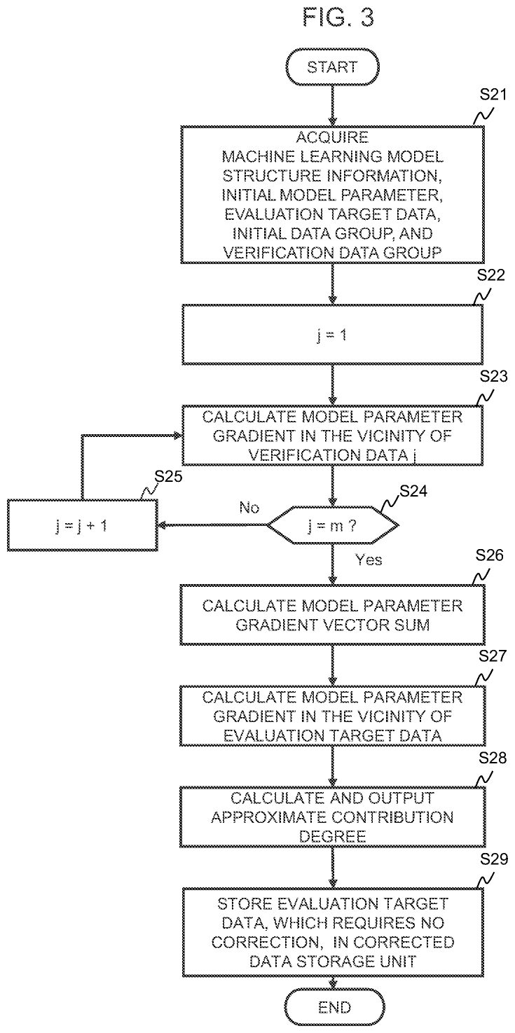

FIG. 3 is a flowchart illustrating a processing sequence of the machine learning system according to Embodiment 3. In order to implement the calculation of the contribution degree of Mathematical Expression 13, the contribution degree calculation unit 105 executes steps S21 to S28 below as illustrated in FIG. 3 in this embodiment. In the processing in step S27, the evaluation target data correction unit 104 stores the evaluation target data Zₑᵥₐₗ, which requires not correction, in the corrected data storage unit 103 on the basis of the approximate contribution degree calculated in step S26.

Step S21: Acquire the machine learning model structure information, the initial model parameter Bina, the initial data group Z_{train,k} (k=1, 2, . . . , n), the evaluation target data Zₑᵥₐₗ, and the verification data group Z_{vaid,j} (j=1, 2, . . . , m).

Step S22: Set the verification data quantity counter j to 1.

Step S23: Calculate a model parameter gradient vector uⱼ in the vicinity of the verification data Z_{vaid,j} according to Mathematical Expression 14.

[Math. 14]

uⱼ=∇_{θ}L(Z_{valid,j},θᵢₙᵢₜ)

Step S24: If the verification data quantity counter j is equal to the verification data quantity m, proceed to step S6; and if the verification data quantity counter j is not equal to the verification data quantity m, proceed to step S5.

Step S25: Add 1 to the verification data quantity counter j and return to the processing in step S3.

Step S26: Calculate a model parameter gradient vector sum uₛᵤₘ by summing up model parameter gradient vectors uⱼ in the vicinity of the verification data Z_{vaid,j} through the entire verification data group Z_{vaid,j} (j=1, 2, . . . , m) according to Mathematical Expression 15. Incidentally, an average of the model parameter gradient vectors may be used instead of the sum uₛᵤₘ of the model parameter gradient vectors.

[Math. 15]

uₛᵤₘ=Σⱼ₌₁^{m}uⱼ

Step S27: Firstly, calculate the inverse HVP which is given by Mathematical Expression 16.

[Math. 16]

A=H⁻¹uₛᵤₘ

Since the calculation of the inverse HVP which becomes dominant in the calculation time of the contribution degree is performed only once by using the model parameter gradient vector sum uₛᵤₘ, it is possible to reduce the calculation time considerably as compared to the case where the inverse HVP is calculated with respect to each piece of verification data.

Then, a model parameter gradient vector v in the vicinity of the evaluation target data is calculated according to Mathematical Expression 17.

[Math. 17]

v=∇_{θ}L(zₑᵥₐₗ,θᵢₙᵢₜ)

Step S28: Calculate and output the contribution degree f(Zₑᵥₐₗ) given by Mathematical Expression 18.

$$f ( {z}_{eval} ) ≅ \frac{1}{m n} v A {u}_{s u m} \qquad [ Math . 18 ]$$

In step S29, the evaluation target data correction unit 104 determines that the evaluation target data Zₑᵥₐₗ whose contribution degree f(Zₑᵥₐₗ) is negative requires no correction, and stores it in the corrected data storage unit 103.

<<Advantageous Effect of Embodiment 3>>

Since the contribution degree calculation unit 105 performs the calculation of the inverse HVP, which becomes dominant in the calculation time of the contribution degree, only once according to this embodiment, it is possible to reduce the calculation time considerably as compared to the case where the inverse HVP is calculated with respect to each piece of verification data.

### Embodiment 4

<<Outline of Embodiment 4>>

This embodiment relates to manual correction of the evaluation target data. As compared to Embodiment 1, this embodiment is different in that the machine learning system 100 further includes an input unit 109D and a display unit 110D. With the machine learning system 100, the evaluation target data correction unit 104 presents information including the evaluation target data and the contribution degree to the user on the display unit 110D. Furthermore, with the machine learning system 100, the evaluation target data correction unit 104 corrects the evaluation target data on the basis of information which is input by the user from the input unit 109D according to the display on the display unit 110D.

In Embodiment 1, if the data quantity of the verification data group is not sufficient to represent the population of the learning data, the contribution degree cannot accurately indicate whether the change of the performance with respect to the population of the model is good or bad, and the correction necessity judgment by the evaluation target data correction unit 104 thereby becomes inaccurate. Therefore, the machine learning system 100 according to this embodiment enhances the accuracy of the correction necessity judgment by having the following configuration.

<<Configuration of Machine Learning System 100 According to Embodiment 4>>

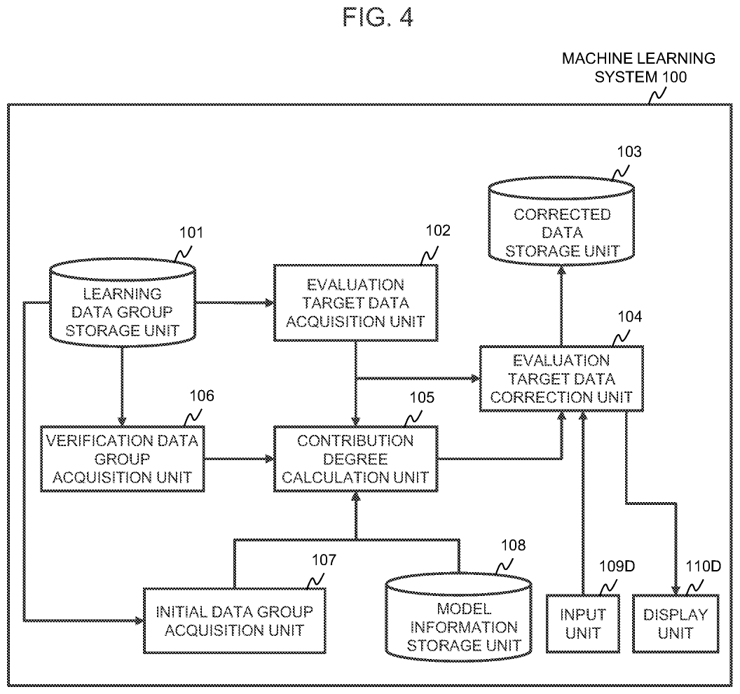

FIG. 4 illustrates a configuration example of the machine learning system 100 according to Embodiment 4. As compared to the machine learning system 100 according to Embodiment 1, the machine learning system 100 further includes the input unit 109 and the display unit 110 and the processing of the evaluation target data correction unit 104 is different.

The display unit 110D is, for example, a display for displaying the evaluation target data correction form 1000. The input unit 109D is, for example, a keyboard, a mouse, and a touch panel for the user to input information.

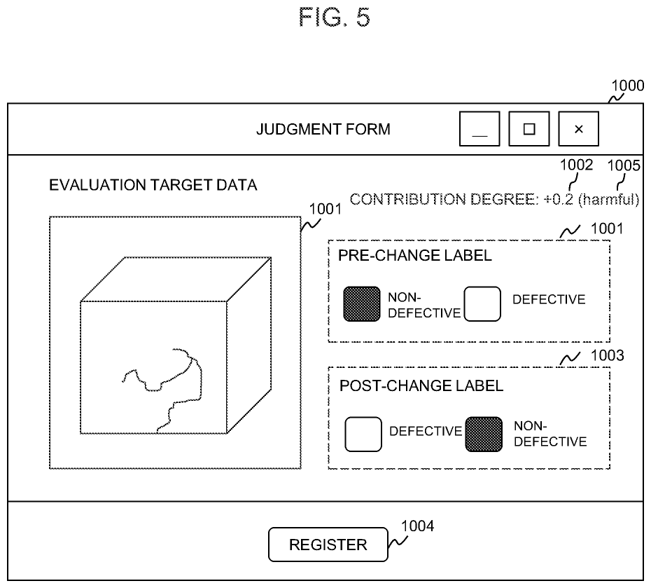

The evaluation target data correction unit 104 according to this embodiment acquires the contribution degree from the contribution degree calculation unit 105, acquires the evaluation target data Zₑᵥₐₗ from the evaluation target data acquisition unit 102, and outputs an evaluation target data correction form 1000 including the acquired information to the display unit 110. FIG. 5 is a diagram illustrating a display example of the evaluation target data correction form 1000 according to Embodiment 4.

Furthermore, the evaluation target data correction unit 104 according to this embodiment changes the label information of the evaluation target data Zₑᵥₐₗ on the basis of the changed label information of the evaluation target data Zₑᵥₐₗ, which is input from the input unit 109D to the evaluation target data correction form 1000, and stores the evaluation target data Zₑᵥₐₗ, whose label information has been changed, in the corrected data storage unit 103.

Referring to FIG. 5, the evaluation target data correction form 1000 includes: an evaluation target data display area 1001 which is an area for displaying the evaluation target data Zₑᵥₐₗ; a contribution degree display area 1002 which is an area for displaying the contribution degree; an influence tendency information display area 1005 which indicates information about whether the change of the performance of the learning model is good or bad; an evaluation target data correction information input area 1003 which is an area for the user to input the changed label information; and a confirmation input area 1004 which is used when the user confirms the correction information.

In this embodiment, the evaluation target data correction unit 104 displays the facility appearance image and the label information of the evaluation target data Zₑᵥₐₗ in the evaluation target data display area 1001, places character strings like “harmful” (when the contribution degree is positive) and “helpful” (when the contribution degree is 0 or negative) in the influence tendency information display area 1005, and displays the changed label information in the evaluation target data correction information input area 1003.

<<Advantageous Effect of Embodiment 4>>

According to this embodiment, whether it is necessary to correct the evaluation target data or not can be judged accurately even if the contribution degree cannot accurately indicate whether the change of the performance with respect to the population is good or bad.

<<Variations of Embodiment 4>>

This embodiment has been described about the case where the label information of the evaluation target data is changed on the basis of the information which is input by the evaluation target data correction unit 104 from the input unit 109D; however, this embodiment is not limited to this example. The evaluation target data correction unit 104 may decide whether to store the evaluation target data in the corrected data storage unit 103 or not, on the basis of the information which is input from the input unit 109D. In this case, the evaluation target data correction information input area 1003 further includes a form to select whether to store the evaluation target data in the corrected data storage unit 103 or not.

Furthermore, this embodiment is designed so that the evaluation target data correction unit 104 always output the evaluation target data to the display unit 110D; however, if the contribution degree is equal to or smaller than a certain threshold value, it may be determined that the evaluation target data requires no correction, and such evaluation target data may not be output. This is because when an absolute value of the contribution degree is large, it is expected that the contribution degree will accurately indicate whether the influence on the model performance is good or bad; and according to this variation, it is possible to reduce the burden of the user's correction work.

### Embodiment 5

<<Outline of Embodiment 5>>

This embodiment relates to manual correction of the verification data by the user when the verification data group includes the verification data which requires to be corrected in Embodiment 1. As compared to Embodiment 1, this embodiment is different in that the machine learning system 100 further includes an input unit 109E and a display unit 110E. With the machine learning system 100, the verification data group correction unit 111 presents information including the verification data to the user on the display unit 110E. Furthermore, with the machine learning system 100, the verification data group correction unit 111 corrects the verification data on the basis of information which is input by the user from the input unit 109E according to the display of the display unit 110E.

<<Configuration of Machine Learning System 100 According to Embodiment 5>>

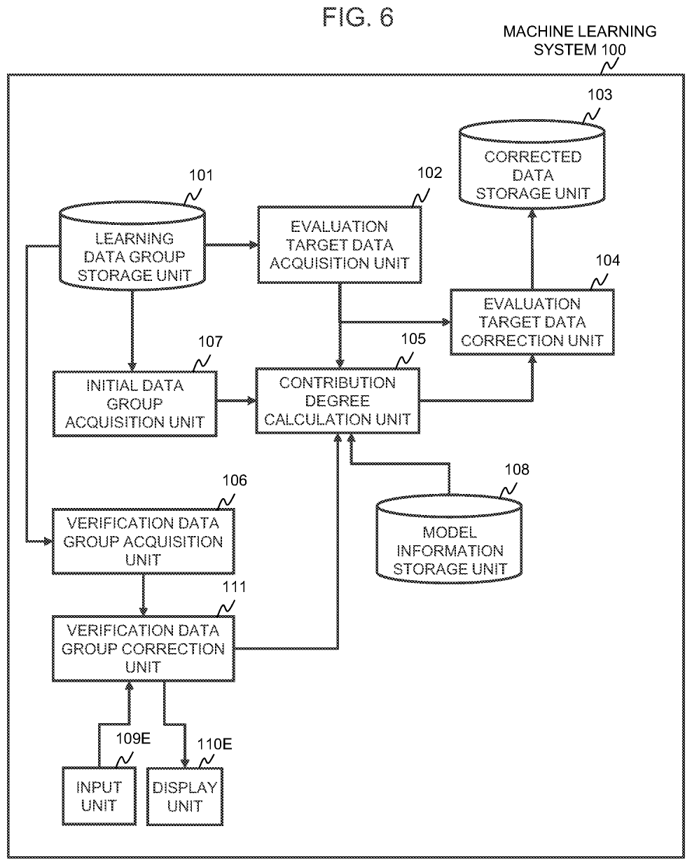

FIG. 6 is a block diagram illustrating a configuration example of the machine learning system 100 according to Embodiment 5. As compared to the machine learning system 100 according to Embodiment 1, the machine learning system 100 according to Embodiment 5 is different in that it further includes the verification data group correction unit 111, the input unit 109E, and the display unit 110E and the processing of the contribution degree calculation unit 105 is different.

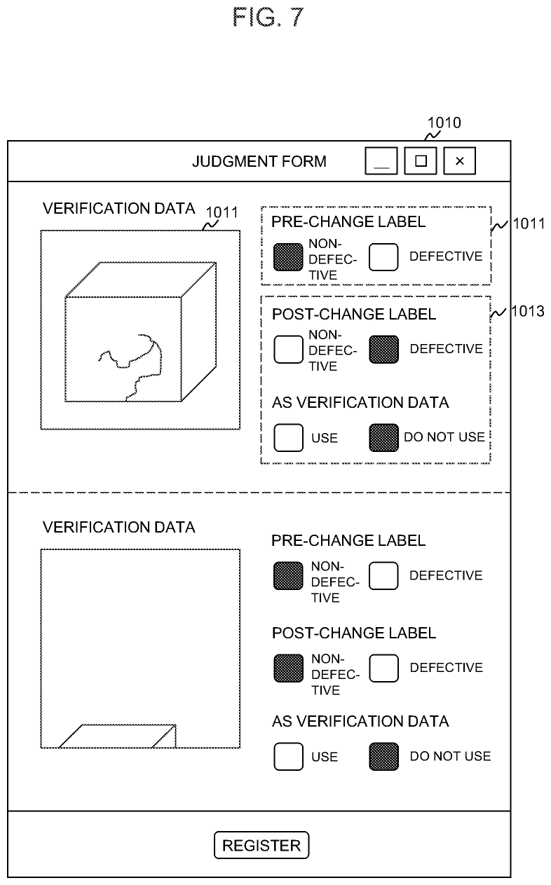

The display unit 110E is a display for displaying a verification data group correction form 1010. FIG. 7 is a diagram illustrating a display example of the verification data group correction form 1010 according to Embodiment 5.

The verification data group correction unit 111 inputs the verification data group acquired by the verification data group acquisition unit 106. The verification data group correction unit 111 outputs the verification data group correction form 1010 to the display unit 110E and outputs the verification data group, which has been corrected on the basis of the information input from the input unit 109E to the verification data group correction form 1010, to the contribution degree calculation unit 105.

In this embodiment, the verification data group correction unit 111 corrects the label information of the verification data group on the basis of correction information, which is input from the input unit 109E, and outputs the verification data, which is designated by the user to use it as the verification data group, to the contribution degree calculation unit 105.

The verification data group correction form 1010 illustrated in FIG. 7 includes: a verification data group display area 1011 which is an area for displaying the verification data group; and a verification data group correction information input area 1013 for the user to input the correction information.

In this embodiment, the verification data group correction unit 111 displays the facility appearance image and the label information, which are the verification data group, in the verification data group display area 1011. Furthermore, the verification data group correction unit 111 displays a form capable of inputting whether defective or non-defective and a form to select whether or not to store the corrected verification data in the corrected data storage unit 103 in order to use the corrected verification data as the verification data group, in the verification data group correction information input area 1013.

<<Advantageous Effect of Embodiment 5>>

According to this embodiment, whether the evaluation target data requires to be corrected or not can be judged with good accuracy even if the verification data group includes the learning data which requires to be corrected.

### Embodiment 6

<<Outline of Embodiment 6>>

This embodiment is the case where the contribution degree is calculated with regard to only some of model parameters in Embodiment 2. This is to solve the problem of lowering of the approximate accuracy of the contribution degree if the number of dimensions of the model parameter is large in Embodiment 1.

Firstly, the cause of this problem will be explained. It is assumed that the model parameter is optimized by using the stochastic gradient descent using a mini batch. The cause of the aforementioned problem is that convergence of learning is assumed for the approximation calculation of the contribution degree; and the convergence of learning becomes difficult when model parameter dimensionality is large. The convergence of learning herein means to satisfy the condition of Mathematical Expression 19.

$$\frac{1}{T n} {\sum }_{t = 1}^{T} {\sum }_{k = 1}^{n} {∇}_{{θ}_{t}} L ( {z}_{train , k} , {θ}_{i n i t} ) < ϵ \qquad [ Math . 19 ]$$

It should be noted, however, that T represents the model parameter dimensionality, c is a convergence condition value, and the convergence condition value c is a sufficiently small value as compared to a value of the left side of Mathematical Expression 19 at the start of optimization.

The reason why the convergence of learning becomes difficult when the model parameter dimensionality is large is because the convergence requires a long calculation time. Furthermore, it is generally possible to shorten the time required for the convergence by increasing the mini batch size. However, when the model parameter dimensionality is large, generally the number of dimensions of an internal feature amount is also large and the memory usage per piece of learning data increases in proportion to the number of dimensions of the internal feature amount. Accordingly, it is difficult to increase the mini batch size. An explanation will be provided below about the configuration to solve this problem by facilitating the convergence of learning.

<<Configuration of Machine Learning System 100 According to Embodiment 6>>

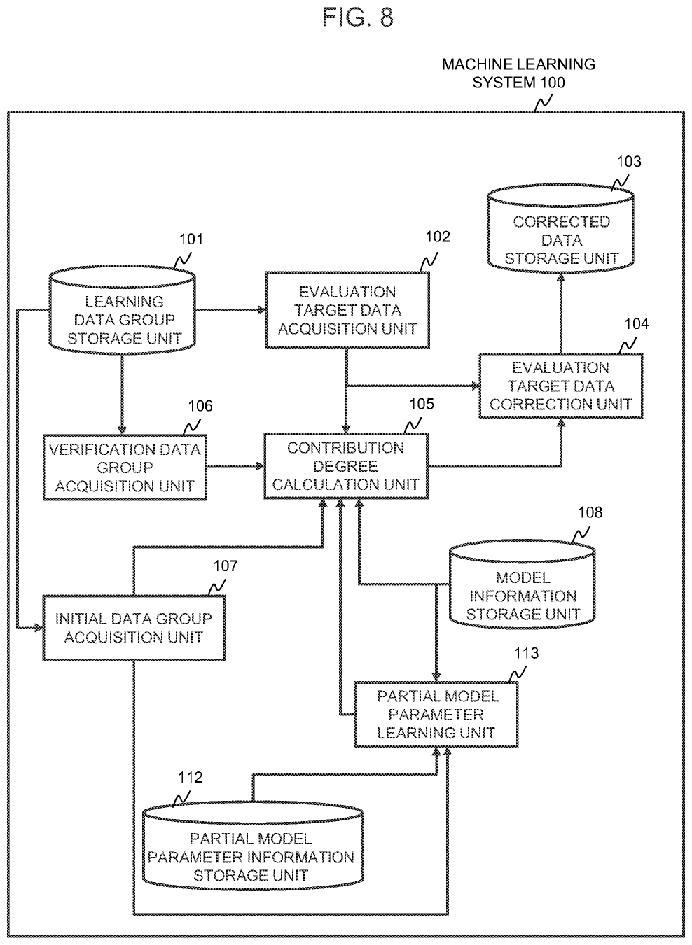

FIG. 8 is a block diagram illustrating a configuration example of the machine learning system 100 according to Embodiment 6. As compared to the machine learning system 100 according to Embodiment 1, the machine learning system 100 according to Embodiment 6 further includes a partial model parameter information storage unit 112 and a partial model parameter learning unit 113 and the processing of the evaluation target data correction unit 104 and the contribution degree calculation unit 105 is different.

The partial model parameter information storage unit 112 stores partial model parameter information which is required to obtain a partial model parameter. The partial model parameter is some of parameters included in the model parameter and is composed of one or more elements regarding which the number of dimensions is smaller than that of the model parameter. Accordingly, regarding the partial model parameter, the memory amount required to calculate a gradient of the partial model parameter is smaller than the memory amount required to calculate gradients of all the model parameters.

For example, if the machine learning model has a multi-layer structure and has model parameter matrixes corresponding to the respective layers, the partial model parameter is a last-layer model parameter matrix corresponding to the last layer which is the layer closet to output. In this case, only a feature amount, an output value, and an output gradient value which are input to the last layer are required in order to calculate a gradient of the last-layer model parameter matrix and it is unnecessary to retain a feature amount or a gradient value on the input side relative to the last layer. Consequently, the partial model parameter has such a feature that it requires a smaller memory amount than the memory amount needed to calculate the gradients of all the model parameters.

Furthermore, the model parameter information is an index value assigned to each layer sequentially from the last layer. In this embodiment, the partial model parameter information is set by the user in advance and is saved in the partial model parameter information storage unit 112.

The partial model parameter learning unit 113 acquires the partial model parameter information from the partial model parameter information storage unit 112, the machine learning model structure information and the initial model parameter from the model information storage unit 108, and the initial data group from the initial data group acquisition unit 107 and performs the optimization indicated with Mathematical Expression 20 on the basis of these pieces of acquired information, thereby obtaining an initial partial model parameter, which is the solution, by learning.

$${θ}_{sub , init} := {argmin}_{{θ}_{sub}} \frac{1}{n} {\sum }_{k = 1}^{n} {L}_{sub} ( {z}_{train , k} , {θ}_{sub} ) \qquad [ Math . 20 ]$$

In Mathematical Expression 20, however, L_{sub} is a loss function regarding the partial model parameter of the machine learning model. The optimization indicated with Mathematical Expression 20 uses the stochastic gradient descent and the mini batch size is larger than the mini batch size used by the learning unit (which is not illustrated in the drawing). Consequently, the time required for the convergence of learning is shortened as compared to the case where all model parameters are used, so that the convergence of learning can be easily implemented.

Incidentally, regarding an initial value of the optimization of Mathematical Expression 20, the initial model parameter may be used as the initial value or a value sampled from a probability distribution such as a Gaussian distribution or a uniform distribution or a constant like 0 which is defined in advance may be used as the initial value.

The contribution degree calculation unit 105 acquires the machine learning model structure information and an initial partial model parameter from the model information storage unit 108, the evaluation target data from the evaluation target data acquisition unit 102, the verification data group from the verification data group acquisition unit 106, the initial data group from the initial data group acquisition unit 107, and an initial partial parameter from the partial model parameter learning unit 113. Then, the contribution degree calculation unit 105 outputs a partial contribution degree f_{sub}(Zₑᵥₐₗ) on the basis of these pieces of acquired data. The partial contribution degree f_{sub}(Zₑᵥₐₗ) is given by Mathematical Expression 21 by using the partial model parameter θ_{sub}.

$$\begin{matrix}{f}_{sub} ( {z}_{eval} ) := \frac{1}{m} {\sum }_{j = 1}^{m} L ( {z}_{valid , j} , {θ}_{sub , add} ( {z}_{eval} ) ) - \frac{1}{m} {\sum }_{j = 1}^{m} L ( {z}_{valid , j} , {θ}_{sub , init} ) where & [ Math . 21 ] \\ {θ}_{sub , add} ( {z}_{eval} ) = {argmin}_{{θ}_{sub}} \frac{1}{n} ( {\sum }_{k = 1}^{n} L ( {z}_{train , k} , {θ}_{sub} ) + L ( {z}_{eval} , {θ}_{sub} ) ) & [ Math . 22 ]\end{matrix}$$

Furthermore, the calculation cost of the right side of Mathematical Expression 21 is large, so that an approximate value expressed by Mathematical Expression 23 is used as the partial contribution degree f_{sub}(Zₑᵥₐₗ) in the same manner as in Embodiment 1.

$${f}_{sub} ( {z}_{e v a l} ) ≅ \frac{1}{m n} {\sum }_{j = 1}^{m} {∇}_{{θ}_{sub}} {L ( {z}_{e v a l} , {θ}_{sub , init} )}^{T} {H}_{sub}^{- 1} {∇}_{{θ}_{sub}} L ( {z}_{valid , j} , {θ}_{sub , init} ) \qquad [ Math . 23 ]$$

where a partial Hessian matrix H_{sub} is given by the following expression.

$${H}_{sub} := \frac{1}{n} {\sum }_{k = 1}^{n} {∇}_{{θ}_{sub}}^{2} L ( {z}_{train , i} , {θ}_{init} ) \qquad [ Math . 24 ]$$

Furthermore, in this embodiment, an inverse HVP is obtained by calculating the product of the inverse matrix of the partial Hessian matrix H_{sub} and a partial model parameter gradient vector in the vicinity of the verification data as indicated in Mathematical Expression 25 in the same manner as in Embodiment 2.

[Math. 25]

A=H_{sub}⁻¹∇_{θ}_{_{sub}}L(Z_{valid,j,θsub,init})

Since the convergence of learning is easy regarding the partial model parameter, the partial contribution degree f_{sub}(Zₑᵥₐₗ) is expected to be capable of approximation with good accuracy. Furthermore, the first term on the right side of Mathematical Expression 21 is an average value of the loss obtained by performing partial additional relearning to learn the partial model parameter of the machine learning model by using the learning data group, which is obtained by adding the evaluation target data to the learning data group, and inputting the verification data group to the machine learning model obtained by the partial additional relearning. Therefore, the partial contribution degree f_{sub}(Zₑᵥₐₗ) is a value different from the contribution degree in Embodiment 1.

However, the partial model parameter is a model parameter which is close to the output layer in the machine learning model, so it is thought that the influence which any change of that value has on the loss is significant as compared to other model parameters. Accordingly, the partial contribution degree f_{sub}(Zₑᵥₐₗ) can be expected to have a high correlation with the contribution degree in Embodiment 1. Therefore, this embodiment also has the advantageous effect of being capable of easily judge whether the correction is required or not on the basis of whether the partial contribution degree f_{sub}(Zₑᵥₐₗ) is positive or negative in the same manner as in Embodiment 1.

The evaluation target data correction unit 104 is designed to acquire the partial contribution degree in the same manner as the evaluation target data correction unit 104 according to Embodiment 1 acquires the contribution degree; and other functions are similar to those of Embodiment 1.

<<Advantageous Effect of Embodiment 6>>

According to this embodiment, it is possible to easily judge whether the evaluation target data requires to be corrected or not, by using the partial model parameter even if the model parameter quantity is large and the contribution degree cannot be calculated with good approximate accuracy.

<<Computer for Implementing Machine Learning System 100>>

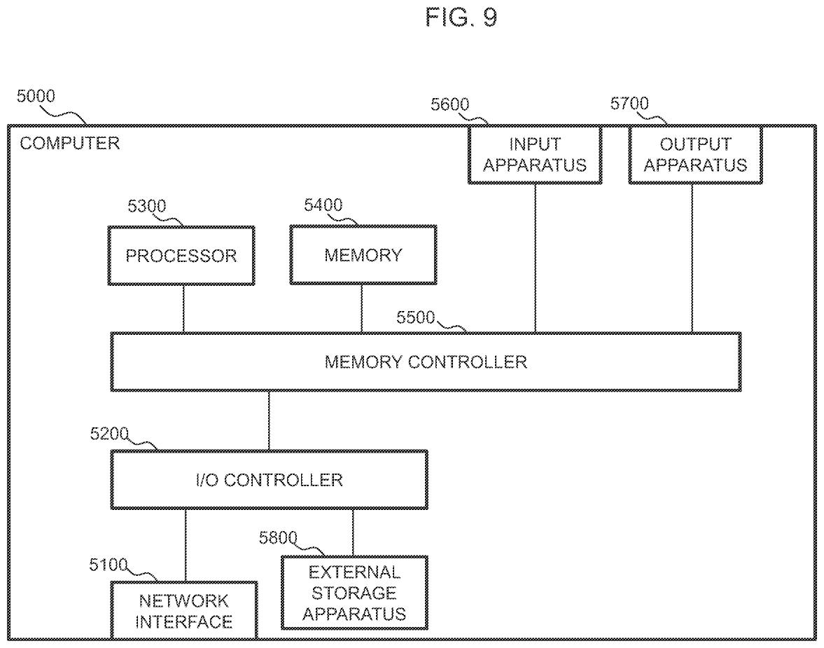

FIG. 9 is a hardware diagram of a computer 5000 for implementing the machine learning system 100. Regarding the computer 5000 for implementing the machine learning system, a processor 5300 represented by a CPU (Central Processing Unit), a memory 5400 such as a RAM (Random Access Memory), an input apparatus 5600 (for example, a keyboard, a mouse, and a touch panel), and an output apparatus 5700 (for example, a video graphic card coupled to an external display monitor) are coupled to each other via a memory controller 5500.

With the computer 5000, a program for implementing the machine learning system is read from an external storage apparatus 5800 such as an SSD or an HDD via an I/O (Input/Output) controller 5200 and is executed by cooperation between the processor 5300 and the memory 5400. Consequently, the machine learning system is implemented. Alternatively, the program for implementing the machine learning system may be acquired from an external computer by communication via a network interface 5100 or may be read or acquired from a recording medium by a medium reading apparatus.

The present invention is not limited to the aforementioned embodiments, but includes various variations. For example, the aforementioned embodiments have been described in detail in order to explain the present invention in an easily comprehensible manner and are not necessarily limited to those having all the configurations explained above. Furthermore, unless any contradiction occurs, part of the configuration of a certain embodiment can be replaced with the configuration of another embodiment and the configuration of another embodiment can be added to the configuration of a certain embodiment. Also, regarding part of the configuration of each embodiment, it is possible to add, delete, replace, integrate, or distribute the configuration. Furthermore, the configurations and processing indicated in the embodiments can be distributed, integrated, or replaced as appropriate on the basis of processing efficiency or implementation efficiency as long as the processing results are the same.

### REFERENCE SIGNS LIST

100: machine learning system
101: learning data group storage unit
102: evaluation target data acquisition unit
103: corrected data storage unit
104: evaluation target data correction unit
105: contribution degree calculation unit
106: verification data group acquisition unit
107: initial data group acquisition unit
108: model information storage unit
109, 109D, 109E: input unit
110, 110D, 110E: display unit
111: verification data group correction unit
112: partial model parameter information storage unit
113: partial model parameter learning unit
5000: computer
5300: processor
5400: memory

1. A machine learning system comprising:
an acquisition unit that acquires an initial data group used to learn a learning model, evaluation target data added to, or excluded from, the initial data group, and a verification data group including at least one element which is not included in the evaluation target data; and
a contribution degree calculation unit that calculates a contribution degree for evaluating an influence which the evaluation target data has on performance of the learning model, on the basis of an output value by the learning model for which the verification data group is input, and an output value by a relearning model which is learned by adding or excluding the evaluation target data to or from the initial data group.

2. The machine learning system according to claim 1,
further comprising an evaluation target data correction unit that corrects the evaluation target data on the basis of the contribution degree.

3. The machine learning system according to claim 2,
wherein the evaluation target data correction unit presents the contribution degree and the evaluation target data to a user and corrects the evaluation target data on the basis of information which is input by the user on the basis of the presentation.

4. The machine learning system according to claim 1,
further comprising a verification data correction unit that presents the verification data group to a user and corrects the verification data group on the basis of information which is input by the user on the basis of the presentation.

5. The machine learning system according to claim 1,
wherein the contribution degree calculation unit: performs approximation calculation, by using an approximation calculation method, of an inverse HVP (Hessian Vector Product) that is a product of an inverse matrix of a Hessian matrix, which is given based on the initial data group and an initial model parameter of the learning model, and a model parameter gradient vector in the vicinity of the verification data group which is given based on the initial model parameter; and calculates an approximate contribution degree of the contribution degree by using a result of the approximation calculation and the model parameter gradient vector in the vicinity of the evaluation target data.

6. The machine learning system according to claim 1,
wherein the contribution degree calculation unit: performs approximation calculation, by using an approximation calculation method, of an inverse HVP (Hessian Vector Product) that is a product of an inverse matrix of a Hessian matrix, which is given based on the initial data group and an initial model parameter of the learning model, and a sum or an average of model parameter gradient vectors in the vicinity of each verification data of the verification data group which is given based on the initial model parameter; and
calculates an approximate contribution degree of the contribution degree on the basis of a result of the approximation calculation, the model parameter gradient vectors in the vicinity of the evaluation target data, and the sum and the average.

7. The machine learning system according to claim 1,
further comprising a partial model parameter learning unit that learns an initial partial model parameter of the learning model by using a partial model parameter among model parameters of the learning model, an initial model parameter of the learning model, and the initial data group,
wherein the contribution degree calculation unit calculates an approximate contribution degree of the contribution degree on the basis of an inverse HVP (Hessian Vector Product) obtained by calculating a product of an inverse matrix of a partial Hessian matrix, which is given on the basis of the initial data group and the partial model parameter, and a partial parameter gradient vector in the vicinity of the verification data group which is given on the basis of the verification data group and the initial partial model parameter.

8. A machine learning method performed by a machine learning system,
the machine learning system:
acquiring an initial data group used to learn a learning model, evaluation target data added to, or excluded from, the initial data group, and a verification data group including at least one element which is not included in the evaluation target data; and
calculating a contribution degree for evaluating an influence which the evaluation target data has on performance of the learning model, on the basis of an output value by the learning model for which the verification data group is input, and an output value by a relearning model which is learned by adding or excluding the evaluation target data to or from the initial data group.

9. The machine learning method according to claim 8,
wherein the machine learning system corrects the evaluation target data on the basis of the contribution degree.

10. The machine learning method according to claim 9,
wherein the machine learning system presents the contribution degree and the evaluation target data to a user and corrects the evaluation target data on the basis of information which is input by the user on the basis of the presentation.

11. The machine learning method according to claim 8,
wherein the machine learning system presents the verification data group to a user and corrects the verification data group on the basis of information which is input by the user on the basis of the presentation.

12. The machine learning method according to claim 8,
wherein the machine learning system: performs approximation calculation, by using an approximation calculation method, of an inverse HVP (Hessian Vector Product) that is a product of an inverse matrix of a Hessian matrix, which is given based on the initial data group and an initial model parameter of the learning model, and a model parameter gradient vector in the vicinity of the verification data group which is given based on the initial model parameter; and calculates an approximate contribution degree of the contribution degree by using a result of the approximation calculation and the model parameter gradient vector in the vicinity of the evaluation target data.

13. The machine learning method according to claim 8,
wherein the machine learning system: performs approximation calculation, by using an approximation calculation method, of an inverse HVP (Hessian Vector Product) that is a product of an inverse matrix of a Hessian matrix, which is given based on the initial data group and an initial model parameter of the learning model, and a sum or an average of model parameter gradient vectors in the vicinity of each verification data of the verification data group which is given based on the initial model parameter; and
calculates an approximate contribution degree of the contribution degree on the basis of a result of the approximation calculation, the model parameter gradient vectors in the vicinity of the evaluation target data, and the sum and the average.

14. The machine learning method according to claim 8,
wherein the machine learning system:
learns an initial partial model parameter of the learning model by using a partial model parameter among model parameters of the learning model, an initial model parameter of the learning model, and the initial data group; and
calculates an approximate contribution degree of the contribution degree on the basis of an inverse HVP (Hessian Vector Product) obtained by calculating a product of an inverse matrix of a partial Hessian matrix, which is given on the basis of the initial data group and the partial model parameter, and a partial parameter gradient vector in the vicinity of the verification data group which is given on the basis of the verification data group and the initial partial model parameter.
